(19) United States
(12) Patent Application Publication
(10) Pub. No.: US 2025/0004447 A1
(43) Pub. Date: Jan. 2, 2025

(54) CONTROL DEVICE AND CONTROL SYSTEM

(71) Applicant: FANUC CORPORATION, Yamanashi (JP)

(72) Inventors: Kiichi TERAMOTO, Yamanashi (JP); Shigeo YOSHIDA, Yamanashi (JP)

(73) Assignee: FANUC CORPORATION, Yamanashi (JP)

(21) Appl. No.: 18/711,839

(22) PCT Filed: Dec. 28, 2021
(86) PCT No.: PCT/JP2021/048872

§ 371 Date: May 20, 2024

(51) Int. Cl. G05B 19/4155

(52) U.S. Cl. CPC G05B 19/4155; G05B 2219/37336

(57) ABSTRACT

Provided is a control device that is for controlling an industrial machine and that can detect missed machining in a simple manner. This control device for controlling an industrial machine using a machining tool comprises: a program execution unit for causing the industrial machine to execute a program that includes a start command for starting a machining process and an end command for ending the machining process by the machining tool; and a counting unit for counting, during execution of the program, the number of times of a completion state indicating that machining abnormality has not occurred in the machining process including the start command and the end command and that each of the commands has been executed and completed.

### TECHNICAL FIELD

The present invention relates to a control device and a control system for controlling an industrial machine.

### BACKGROUND ART

In machining processes such as arc welding and laser machining with industrial machines such as robots and machine tools, a phenomenon often occurs in which a production line temporarily stops due to some abnormality during machining.

Typically, in such cases, an operator intervenes in the production line as needed and performs appropriate measures, and then the production line is restarted. Here, in the machining process, it is desirable that the position where the production line is temporarily stopped and the position where the production line is restarted after the work coincide with each other. However, it is possible that an operator error, the complexity of the machining process, or the like may result in a wrong restart position, and the production line may be restarted with some parts to be machined omitted.

To check whether all necessary machining has been performed, a method of inspecting a workpiece that has been machined is used. However, if a workpiece containing unmachined parts is found, it must undergo a process whereby it is either discarded or returned to the machining line to be remachined, which increases man-hours.

Means for checking during machining rather than after machining has been proposed (for example, see Patent Documents 1 and 2), but this requires checking the video image one by one, which increases man-hours.

### CITATION LIST

### Patent Document

Patent Document 1: Japanese Unexamined Patent Application, Publication No. H5-293647
Patent Document 2: Japanese Unexamined Patent Application, Publication No. H2-255272

### DISCLOSURE OF THE INVENTION

### Problems to be Solved by the Invention

Therefore, there is a demand for a control device and a control system that are for controlling an industrial machine and that can detect machining omissions by a simple method.

### Means for Solving the Problems

A control device for controlling an industrial machine equipped with a machining tool according to one aspect of the present disclosure includes a program executing unit configured to cause the industrial machine to execute a program including a start instruction for starting a machining process with the machining tool and an end instruction for ending the machining process, and a counting unit configured to count a number of completion states each indicating that the machining process including the start instruction and the end instruction does not cause a machining abnormality and each instruction is executed and completed, during execution of the program.

A control system according to one aspect of the present disclosure includes an industrial machine configured to perform a machining process using a machining tool, a program executing unit configured to cause the industrial machine to execute a program including a start instruction for starting the machining process with the machining tool and an end instruction for ending the machining process, and a counting unit configured to count a number of completion states each indicating that the machining process including the start instruction and the end instruction does not cause a machining abnormality and each instruction is executed and completed, during execution of the program.

### Effects of the Invention

According to the present invention, machining omissions can be detected by a simple method.

### BRIEF DESCRIPTION OF THE DRAWINGS

FIG. 1 is a block diagram showing the configuration of a control system according to the present embodiment;

FIG. 2 is a block diagram showing the configuration of a control device according to the present embodiment;

FIG. 3A shows an example of a machining program according to the present embodiment;

FIG. 3B shows a welding process according to the present embodiment;

FIG. 4A shows an example of a machining program according to the present embodiment;

FIG. 4B shows the number of completion states when the machining process is normally completed;

FIG. 4C shows the number of completion states when the machining process is not normally completed;

FIG. 5A shows a completion state when the machining process is normally completed;

FIG. 5B shows a completion state when welding is performed from the middle of a machining path;

FIG. 5C shows a completion state when a machining process is temporarily stopped and welding of a part is skipped in the machining process;

FIG. 6A shows an example of a machining program according to the present embodiment;

FIG. 6B shows a completion state when the machining process is normally completed;

FIG. 6C shows a completion state when the welding process is temporarily stopped in the middle of the process;

FIG. 7A shows an example of a machining program according to the present embodiment; and

FIG. 7B shows a completion state when the machining process is temporarily stopped in the middle of the machining process and is changed to be in single step mode.

### PREFERRED MODE FOR CARRYING OUT THE INVENTION

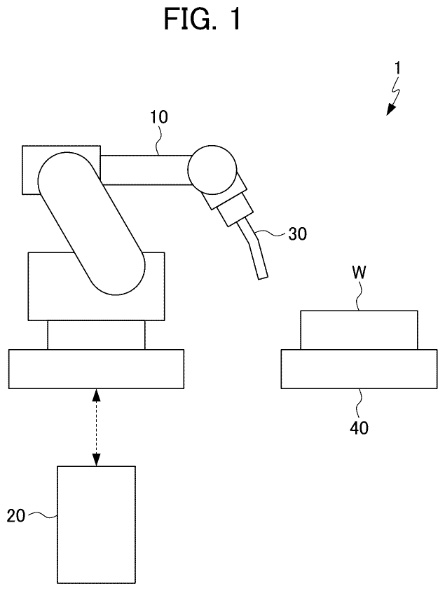

Hereinafter, an embodiment of the present invention will be described. FIG. 1 is a block diagram showing the configuration of a control system 1 according to the present embodiment. The control system 1 is a system for controlling industrial machines such as robots and machine tools. As shown in FIG. 1, the control system 1 includes a robot 10, a control device 20, and a welding torch (machining tool) 30.

The control system 1 performs arc welding on an object W on a jig 40 with a welding torch 30 attached to the leading end of the robot 10 controlled by the control device 20 in accordance with a machining program. In the present embodiment, the control system 1 performs a welding process as a machining process, but the control system 1 is also applicable to other machining processes using industrial machines such as laser machining and cutting.

The control device 20 may be a robot control device or numerical control device for controlling industrial machines such as robots and machine tools. The control device 20 may be a computer device connected to an industrial machine separately from the robot control device or the numerical control device.

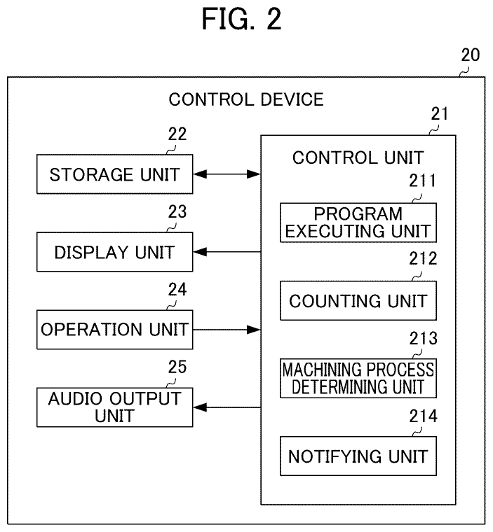

FIG. 2 is a block diagram showing the configuration of the control device 20 according to the present embodiment. As shown in FIG. 2, the control device 20 includes a control unit 21, a storage unit 22, a display unit 23, an operation unit 24, and an audio output unit 25.

The control unit 21 includes a processor such as a CPU (central processing unit) and executes various controls in the control device 20. The control unit 21 includes a program executing unit 211, a counting unit 212, a machining process determining unit 213, and a notifying unit 214.

The storage unit 22 includes storage devices such as ROM (read only memory), RAM (random access memory), HDD (hard disk drive), and SSD (solid state drive), and stores various kinds of information.

The display unit 23 includes a liquid crystal display (LCD), a cathode ray tube (CRT), etc. and displays various kinds of information. The operation unit 24 includes a mouse, a keyboard, etc. and receives various inputs. The audio output unit 25 includes a speaker, etc. and outputs audio under the control of the control unit 21.

The program executing unit 211 causes the robot 10 to execute a machining program including a start instruction for starting a machining process with the welding torch 30 and an end instruction for ending the machining process. During execution of the machining program, the counting unit 212 counts the number of completion states indicating that the machining process including the start instruction and the end instruction does not cause a machining abnormality and each instruction is executed and completed.

Here, the completion state indicates that the machining process including the start instruction, the end instruction, and a condition change instruction does not cause a machining abnormality such as interruption, temporarily stop, or missing weld, and each instruction is executed and completed.

The machining process determining unit 213 compares the number of start instructions and end instructions to be executed in the machining program with the number of completion states, and determines whether the machining process is completed based on the comparison result. The notifying unit 214 outputs the determination result made by the machining process determining unit 213 through the display unit 23 and/or the audio output unit 25 and notifies the user of the determination result.

The machining program further includes a condition change instruction for changing the machining conditions in the machining process, and the counting unit 212 includes execution of the condition change instruction as a completion state.

During execution of the machining program, when the machining process becomes invalid in a partial section of the machining path, the counting unit 212 retains information regarding the invalid machining process. At the end of the machining process, the counting unit 212 does not count the completion state corresponding to the invalid machining process. The counting unit 212 counts a part or all of the number of completion states at the end of the machining process.

The counting unit 212 can set detailed conditions regarding completion states. For example, the counting unit 212 may set, as a detailed condition, whether a completion state is determined when the welding process cannot be started smoothly and the start of the welding process is retried several times.

The counting unit 212 may set, as a detailed condition, whether a completion state is determined when the welding process is temporarily stopped in the middle and is restarted without changing the line of the instruction statement of the machining program.

Similarly, the counting unit 212 may set, as a detailed condition, whether a completion state is determined when a feedback value (e.g., a current value, a voltage value, or the like) related to the machining state deviates from a threshold during the welding process. This detailed condition is applied when the feedback value momentarily deviates from the threshold, but this is not a situation in which alarm notification and stopping of the robot 10 are performed to stop the production line.

The counting unit 212 may set, as a detailed condition, whether a completion state is determined when machining end processing is interrupted in the middle or when the machining end processing fails, during the welding process. When the welding process is arc welding, the robot 10 executes crater processing as machining end processing.

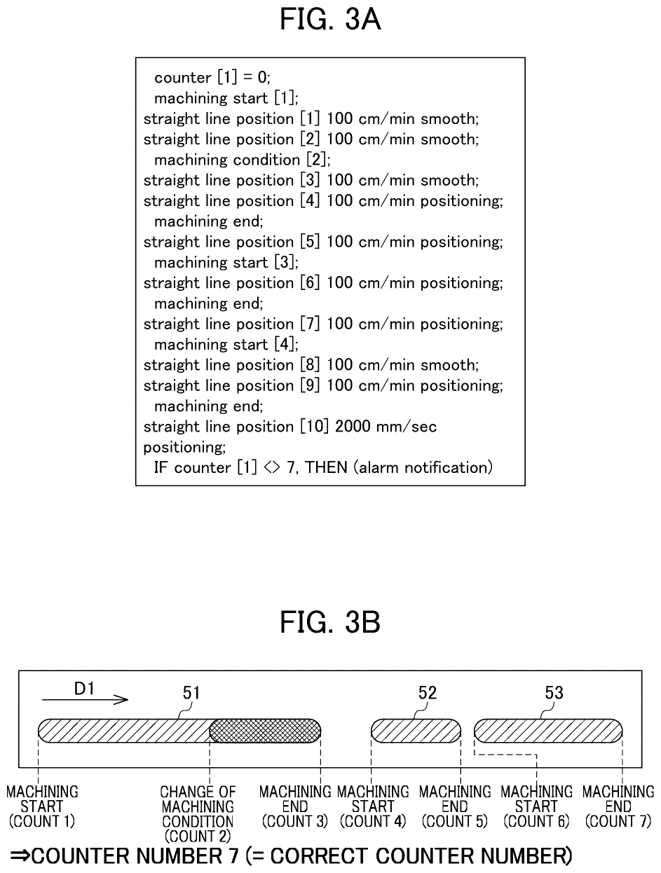

FIG. 3A shows an example of a machining program according to the present embodiment. FIG. 3B shows a welding process according to the present embodiment. The machining program shown in FIG. 3A is a program for causing the robot 10 to execute the welding process with the welding torch 30.

As shown in FIG. 3B, the robot 10 performs the welding process on the workpiece W according to the machining program. In the welding process shown in FIG. 3B, the welding torch 30 is moved in the welding direction D1, and weld beads 51, 52, and 53 are formed on the workpiece W.

Specifically, in the machining program shown in FIG. 3B, the start instruction “machining start [1]” corresponds to the start of machining of the weld bead 51, the start instruction “machining start [3]” corresponds to the start of machining of the weld bead 52, and the start instruction “machining start [4]” corresponds to the start of machining of the weld bead 53.

The three end instructions “machining end” in the machining program correspond to the end of machining of the weld beads 51, 52, and 53, respectively. The machining condition change instruction “machining condition [2]” in the machining program corresponds to a change in the machining conditions of the weld bead 51.

As shown in FIG. 3A, the program executing unit 211 causes the robot 10 to execute the machining program. The machining program executes the instruction “counter [1]=0” to initialize the count of the number of completion states, and the counting unit 212 starts the count of the number of completion states.

Next, the machining program executes instructions from the start instruction “machining start [1]” (start of machining of the weld bead 51) to the end instruction “machining end” (end of machining of the weld bead 53).

Furthermore, the counting unit 212 counts the number of completion states in the machining process from the start instruction “machining start [1]” (start of machining of the weld bead 51) to the end instruction “machining end” (end of machining of the weld bead 53).

For example, as shown in FIG. 3B, when all of the instructions are executed and completed, the counting unit 212 counts the number of instructions from the start instruction “machining start [1]” to the end instruction “machining end”, i.e., “7” as the number of completion states. Here, the counting unit 212 counts the completion state of each of the start instruction “machining start [1]”, the start instruction “machining start [3]”, and the start instruction “machining start [4]” at the end of each machining.

Next, the machining program executes the instruction “IF counter [1]< >7, THEN (alarm notification)”, and the machining process determining unit 213 compares the number of start instructions and end instructions (i.e., “7”) to be executed in the machining program with the number of completion states, and determines whether the machining process is completed based on the comparison result.

When the number of start instructions and end instructions to be executed (i.e., “7”) coincides with the number of completion states, the machining process determining unit 213 determines that the machining process has been normally completed. Then, the notifying unit 214 outputs, as the determination result, the fact that the machining process is completed through the display unit 23 and/or the audio output unit 25 and notifies the user of the determination result.

On the other hand, when the number of start instructions and end instructions to be executed (i.e., “7”) does not coincide with the number of completion states, the machining process determining unit 213 determines that the machining process has not been completed. Then, the notifying unit 214 outputs an alarm notification indicating that the machining process is not completed through the display unit 23 and/or the audio output unit 25 as a determination result, and notifies the user of the determination result. Thus, the user can recognize the presence or absence of a machining omission in the machining process.

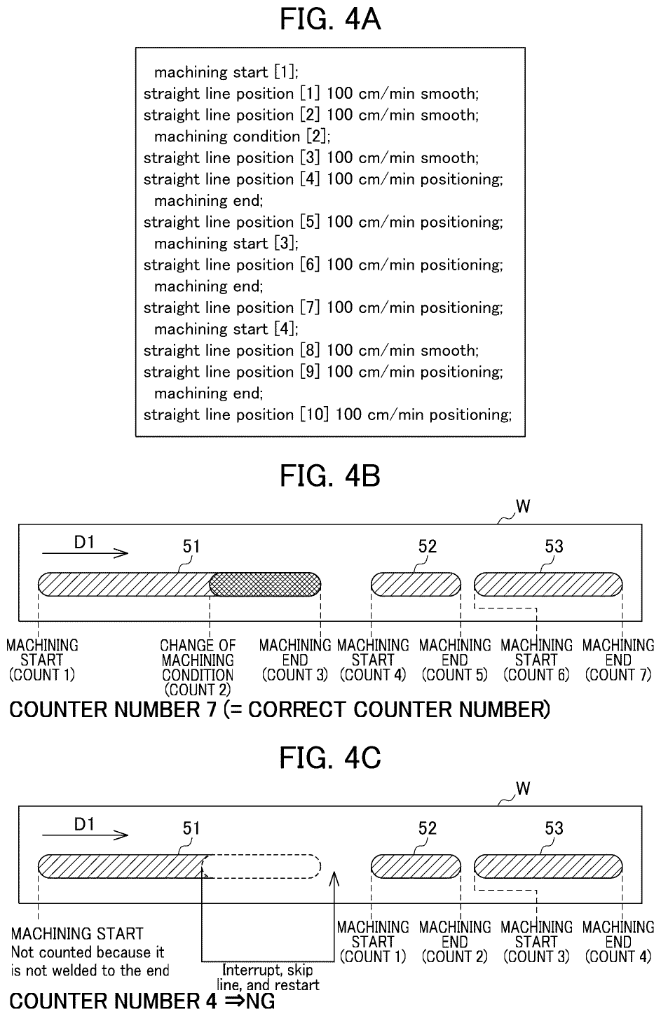

FIG. 4A shows an example of a machining program according to the present embodiment. FIG. 4B shows the number of completion states when the machining process according to the present embodiment is normally completed. FIG. 4C shows the number of completion states when the machining process according to the present embodiment is not normally completed.

The machining program shown in FIG. 4A is a program from the start instruction “machining start [1]” (start of machining of the weld bead 51) to the end instruction “machining end” (end of machining of the weld bead 53) of the machining program shown in FIG. 3.

When the machining program shown in FIG. 4A is executed, the counting unit 212 counts the number of completion states in the machining process from the start instruction “machining start [1]” to the end instruction “machining end”. In the example shown in FIG. 4B, when all the instructions are executed and completed, the counting unit 212 counts the number of completion states “7” from the start instruction “machining start [1]” to the end instruction “machining end”.

On the other hand, in the example shown in FIG. 4C, the machining of the weld bead 51 is temporarily stopped by an operation of the operation unit 24 by the user or the like, and the line of the machining program corresponding to the machining of the weld bead 51 is skipped, and the machining of the next weld bead 52 is started. In this case, the start instruction “machining start [1]” is executed, but the machining condition change instruction “machining condition [2]” and the end instruction “machining end” are not executed and completed.

In this case, the counting unit 212 does not count the number of completion states because each instruction is not executed and completed in the machining process including the above three instructions. The counting unit 212 counts the number of completion states “4” in the machining process from the start instruction “machining start [3]” to the end instruction “machining end” (end of machining of the weld bead 53).

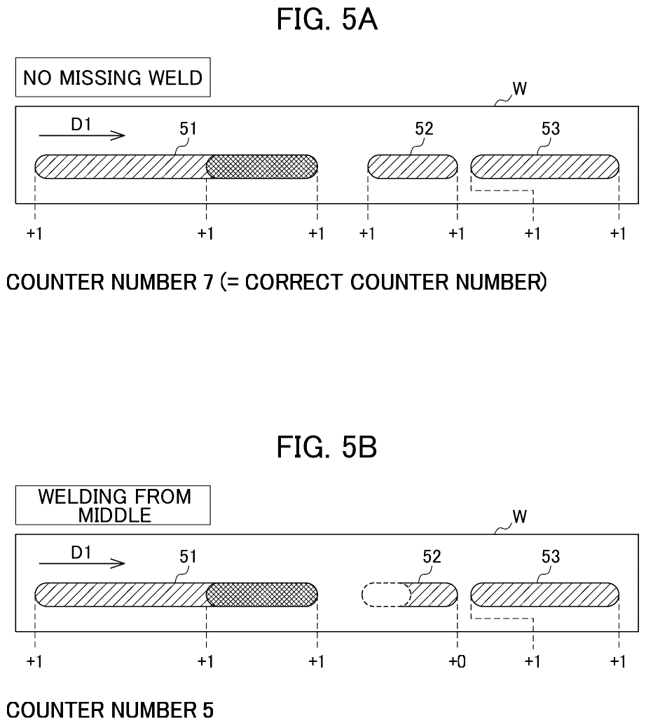

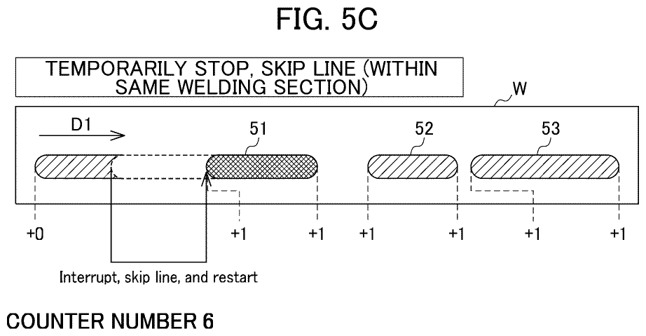

FIGS. 5A to 5C show examples of counting the number of completion states in the machining process. FIG. 5A shows a completion state when the machining process is normally completed in the machining process according to the present embodiment. As described above, in this case, the counting unit 212 counts the number of completion states “7” from the start instruction “machining start [1]” to the end instruction “machining end”.

FIG. 5B shows a completion state when welding is performed from the middle of a machining path in the machining process according to the present embodiment. In the example shown in FIG. 5B, since the start instruction “machining start [3]” is not executed in the welding valid state, and the state is switched to the welding valid state in the middle, the weld bead 52 is formed from the middle, and then the end instruction “machining end” (end of machining of the weld bead 52) is completed.

In this case, since the machining process including the above two instructions is not correctly completed, the counting unit 212 does not count the instructions as completion states.

FIG. 5C shows a completion state when a machining process is temporarily stopped and welding of a part is skipped in the machining process. In the example shown in FIG. 5C, the start instruction “machining start [1]” is executed, but machining is temporarily stopped in the same welding section, the line corresponding to machining of the weld bead 51 in the machining program is skipped, and the machining condition change instruction “machining condition [2]” and the end instruction “machining end” are executed. In this case, since welding in the same machining process corresponding to the start instruction “machining start [1]” has not been completed, the counting unit 212 does not count this as a completion state.

As shown in FIGS. 5B and 5C, during execution of the machining program, when the machining process becomes invalid in a partial section of the machining path, the counting unit 212 retains information regarding the invalid machining process. Then, at the end of the machining process, the counting unit 212 does not count the completion state corresponding to the invalid machining process.

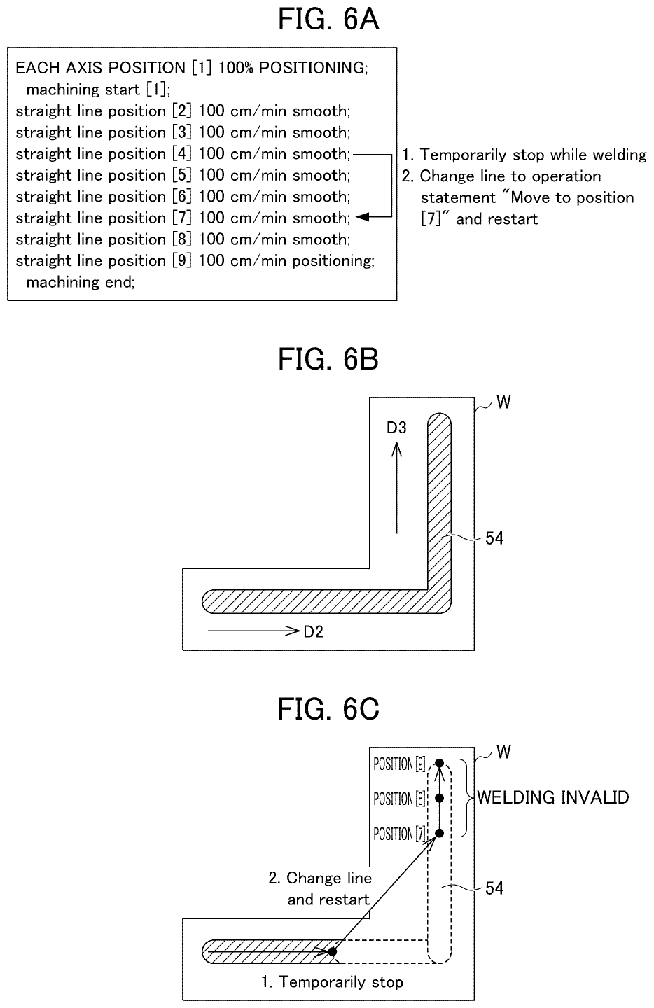

FIG. 6A shows an example of a machining program according to the present embodiment. FIG. 6B shows a completion state when the welding process according to the present embodiment is normally completed. FIG. 6C shows a completion state when the welding process according to the present embodiment is temporarily stopped in the middle of the process.

The machining program shown in FIG. 6A is a program for causing the robot 10 to execute the welding process with the welding torch 30. As shown in FIG. 6B, the robot 10 performs the welding process on the workpiece W according to the machining program. In the welding process shown in FIG. 6B, the welding torch 30 is moved in the welding directions D2 and D3, and a L-shaped weld bead 54 is formed on the workpiece W.

In the example shown in FIG. 6B, the welding process is temporarily stopped during execution of the instruction statement “straight line position [2]”, the line of the instruction statement of the machining program is changed, and the welding process is restarted from the instruction statement “straight line position [7]”. When the line is changed in this manner, the robot 10 does not perform the welding process from the instruction statement “straight line position [7]” to the instruction statement “straight line position [9]”.

In this case, the counting unit 212 retains information regarding the welding process that has become invalid. At the end of the welding process, the counting unit 212 does not count the completion state corresponding to the invalid machining process. That is, in the example shown in FIG. 6B, the counting unit 212 counts “0” as the number of completion states.

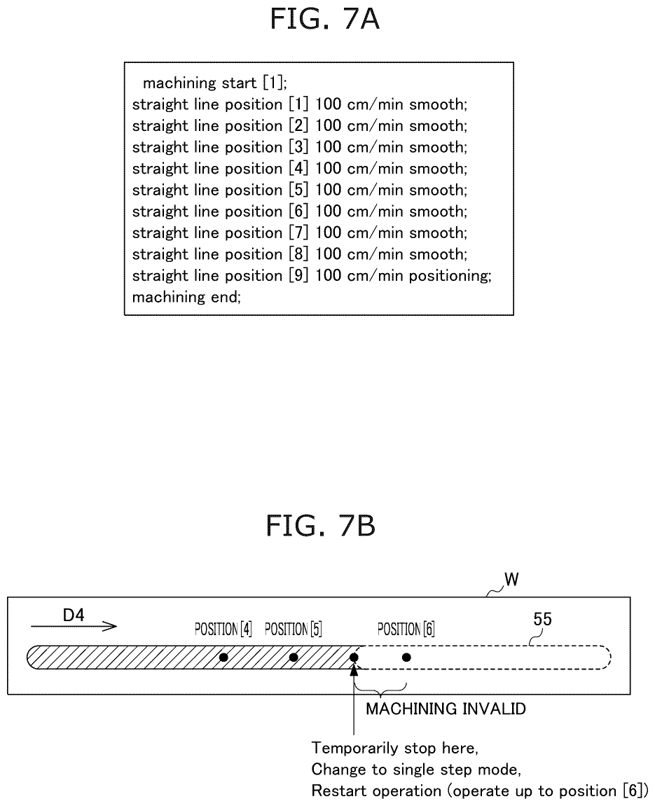

FIG. 7A shows an example of a machining program according to the present embodiment. FIG. 7B shows a completion state when the machining process according to the present embodiment is temporarily stopped in the middle of the machining process and is changed to be in single step mode.

The machining program shown in FIG. 7A is a program for causing the robot 10 to execute a welding process with the welding torch 30. As shown in FIG. 7B, the robot 10 performs a welding process on the workpiece W according to the machining program. In the welding process shown in FIG. 7B, the welding torch 30 is moved in the welding direction D4 to form a linear weld bead 55 on the workpiece W.

In the example shown in FIG. 7B, the welding process is temporarily stopped during execution of the instruction statement “straight line position [5]”, and the operation mode of the robot 10 is changed to single step mode. Here, the single step mode is a mode in which only one line of instruction statement is executed.

When the mode is changed to the single step mode, the robot 10 operates to a position where the instruction “straight line position [6]” is executed, the subsequent instructions are not executed, and the welding process becomes invalid. In this case as well, similarly to the above-described example, the counting unit 212 retains information regarding the invalid welding process. Then, at the end of the welding process, the counting unit 212 does not count the completion state corresponding to the invalid welding process. That is, in the example shown in FIG. 7B, the counting unit 212 counts “0” as the number of completion states.

As described above, according to the present embodiment, the control device 20 includes the program executing unit 211 that causes the robot 10 to execute a machining program including a start instruction for starting a machining process with the welding torch 30 and an end instruction for ending the machining process, and the counting unit 212 that counts the number of completion states each indicating that the machining process including the start instruction and the end instruction does not cause a machining abnormality and each instruction is executed and completed, during the execution of the machining program.

Thus, the control device 20 can detect a machining omission when there is an unexecuted machining instruction or when there is a machining instruction that was executed but the machining process was not appropriately completed. Since the control device 20 counts the number of machining instructions rather than the number of machining operations, the control device 20 can detect a machining omission even when a part of a machining operation is omitted. Furthermore, since the control device 20 checks the number of machining instructions, it is possible to detect machining omissions by a simple method.

The machining process determining unit 213 compares the number of start instructions and end instructions to be executed in the machining program with the number of completion states, and determines whether the machining process is completed based on the comparison result. The notifying unit 214 outputs the determination result made by the machining process determining unit 213 through the display unit 23 and/or the audio output unit 25 and notifies the user of the determination result. Thus, the control device 20 can notify the user of whether the machining process is completed.

The machining program further includes a condition change instruction for changing machining conditions in the machining process, and the counting unit 212 includes execution of the condition change instruction as a completion state. Thus, the control device 20 can more accurately determine completion or non-completion of the machining process by adding the execution of the condition change instruction to the completion states.

When, during execution of the machining program, the machining process becomes invalid in a partial section of the machining path, the counting unit 212 retains information regarding the invalid machining process. The counting unit 212 does not count the completion state corresponding to the invalid machining process at the end of the machining process. The counting unit 212 counts a part or all of the number of completion states at the end of the machining process. Thus, the control device 20 can detect a machining omission even when the instruction is appropriately executed but the machining omission occurs in the middle.

The counting unit 212 can set detailed conditions regarding completion states. Specifically, the counting unit 212 may set, as a detailed condition, whether a completion state is determined when the welding process cannot be started smoothly and the start of the welding process is retried several times. Furthermore, the counting unit 212 may set, as a detailed condition, whether a completion state is determined when the welding process is temporarily stopped in the middle and is restarted without changing the line of the instruction statement of the machining program.

Similarly, the counting unit 212 may set, as a detailed condition, whether a completion state is determined when a feedback value (e.g., a current value, a voltage value, or the like) related to the machining state deviates from a threshold during the welding process. The counting unit 212 may set, as a detailed condition, whether a completion state is determined when the machining end processing is interrupted in the middle or when the machining end processing fails, during the welding process. Such a configuration allows the control device 20 to manage the machining process that meets the purpose of the user.

The embodiment of the present invention has been described above. The above control system 1 and the control device 20 can be implemented by hardware, software, or a combination thereof. The control method performed by the control system 1 and the control device 20 can also be implemented by hardware, software, or a combination thereof. Here, “implemented by software” means implementation by a computer reading and executing a program.

The program may be stored and provided to a computer using various types of non-transitory computer-readable media. The non-transitory computer-readable media include various types of tangible storage media. Examples of the non-transitory computer-readable media include magnetic recording media (e.g., hard disk drives), magneto-optical recording media (e.g., magneto-optical disks), CD-ROMs (read only memories), CD-Rs, CD-R/Ws, and semiconductor memories (e.g., mask ROMs, PROMs (programmable ROMs), EPROMS (erasable PROMs), flash ROMs, and RAMs (random access memories)).

Although the above-described embodiments are preferred embodiments of the present invention, the scope of the present invention is not limited to the above-described embodiments, and various modifications can be made without departing from the gist of the present invention.

### EXPLANATION OF REFERENCE NUMERALS

1 control system
10 robot (industrial machine)
20 control device
21 control unit
22 storage unit
23 display unit
24 operation unit
25 audio output unit
211 program executing unit
212 counting unit
213 machining process determining unit
214 notifying unit
30 welding torch (machining tool)
40 jig
W workpiece

1. A control device for controlling an industrial machine equipped with a machining tool, the control device comprising:
a program executing unit configured to cause the industrial machine to execute a program including a start instruction for starting a machining process with the machining tool and an end instruction for ending the machining process; and
a counting unit configured to count a number of completion states each indicating that the machining process including the start instruction and the end instruction does not cause a machining abnormality and each instruction is executed and completed, during execution of the program.

2. The control device according to claim 1, further comprising
a machining process determining unit configured to compare a number of the start instructions and the end instructions to be executed in the program with the number of the completion states, and determine whether the machining process is completed based on a comparison result; and
a notifying unit configured to notify a determination result made by the machining process determining unit.

3. The control device according to claim 1,
wherein the program further includes a condition change instruction for changing a machining condition in the machining process, and
wherein the counting unit includes execution of the condition change instruction as a completion state.

4. The control device according to claim 1,
wherein, during the execution of the program, when the machining process becomes invalid in a partial section of a machining path, the counting unit retains information regarding the machining process that becomes invalid, and does not count a completion state corresponding to the machining process that becomes invalid at an end of the machining process.

5. The control device according to claim 1, wherein the counting unit counts a part or all of the number of the completion states at an end of the machining process.

6. The control device according to claim 1, wherein the counting unit is capable of setting a detailed condition regarding the completion states.

7. The control device according to claim 6, wherein the counting unit is capable of setting, as the detailed condition, whether a completion state is determined when the machining process is retried.

8. The control device according to claim 6, wherein the counting unit is capable of setting, as the detailed condition, whether a completion state is determined when the machining process is temporarily stopped in a middle and is restarted without changing a line of an instruction statement of the program.

9. The control device according to claim 6, wherein the counting unit is capable of setting, as the detailed condition, whether a completion state is determined when a feedback value related to a machining state deviates from a threshold during the machining process.

10. The control device according to claim 6, wherein the counting unit is capable of setting, as the detailed condition, whether a completion state is determined when machining end processing is interrupted in a middle or when the machining end processing fails, during the machining process.

11. A control system, comprising:
an industrial machine configured to perform a machining process using a machining tool;
a program executing unit configured to cause the industrial machine to execute a program including a start instruction for starting the machining process with the machining tool and an end instruction for ending the machining process; and
a counting unit configured to count a number of completion states each indicating that the machining process including the start instruction and the end instruction does not cause a machining abnormality and each instruction is executed and completed, during execution of the program.
